(19) United States
(12) Patent Application Publication
(10) Pub. No.: US 2017/0005420 A1
(43) Pub. Date: Jan. 5, 2017

(54) PARALLEL SCREW CONNECTION

(71) Applicant: HARTING ELECTRIC GMBH & CO. KG, Espelkamp (DE)

(72) Inventors: Xiafu Wang, Espelkamp (DE); Martin Schmidt, Luebbecke (DE); Nicole Spilker, Luebbecke (DE); Stefan Garske, Bad Essen (DE)

(21) Appl. No.: 15/116,792

(22) PCT Filed: Jan. 21, 2015
(86) PCT No.: PCT/DE2015/100027

§ 371 Date: Aug. 4, 2016

(30) Foreign Application Priority Data
Mar. 20, 2014 (DE) 10 2014 103 826.6

(51) Int. Cl. H01R 4/40; H01R 43/20; H01R 9/26; H01R 4/30; H01R 4/50

(52) U.S. Cl. CPC H01R 4/40; H01R 4/305; H01R 4/505; H01R 9/26; H01R 43/20

(57) ABSTRACT

In parallel screw connections, which are preferably used in series terminals, the transmission of force from the connection screw to electric conductors which have different diameters is not always optimal. As a solution, the clamping element is mounted in or on the connection housing both in a movable manner as well as in a rotational manner about a rotational axis. By screwing the connection screw, the clamping element is moved in the direction of the electric conductor, mechanically contacts the electric conductor, is rotated by further screwing the connection screw about the rotational axis, and thus presses the electric conductor against the busbar with a corresponding degree of force. In this manner, an optimal pressing force is ensured independently of the respective diameter of the electric conductor.

The invention relates to a parallel screw connection according the preamble of the independent main claim 1 and to a method for providing an electrical contact between an electrical conductor and a current rail in accordance with the preamble of the independent coordinated claim 15.

Screw connections of this type are preferably used in terminal blocks and for their part are used by way of example in electrical-control cabinets. Such a screw connection is used within such terminal blocks to provide contact between an electrical conductor, in particular a region of an electrical cable that has been stripped of insulation, and a current rail. The screw connection comprises a connection screw whose axis for space reasons extends in parallel with respect to the inserted electrical conductor and generally also in parallel with respect to the current rail, from which the given name “parallel screw connection” is also derived.

### PRIOR ART

Multiple variants are known in the prior art for deflecting the screw force ideally at a right angle with respect to its original direction so as to provide a contact between the current rail and the electrical conductor.

The publication DE8911218U1 describes a corresponding electrical pressure transmitting element for a connection terminal.

A clamping device for connecting electrical conductors is known from the publication DE 7533712 U1, said clamping device comprising a clamping element that is bent out of a sheet metal strip and has a closed form. The clamping device comprises moreover a pressure transmitting member that can be adjusted by means of a clamping screw, said pressure transmitting member being embodied as a loose clamping bracket that is merely guided by the clamping element, and a clamping screw acts on one end of the clamping bracket and as said clamping screw is actuated the clamping bracket is displaced in the direction towards the conductor insertion duct about a point of rotation that is provided in a recess of the clamping element or is provided loose at any contact point on the clamping element on a retaining protrusion. As a consequence, the inserted conductor is fixedly clamped between the clamping element inner edge and the clamping bracket.

Progressing from this, the publication DE 29902870U1 discloses a clamping device for connecting electrical conductors, said clamping device having a clamping element that is bent in a U-form out of a sheet metal strip, a clamping bracket that is mounted in the clamping element by means of a pendulum bearing arrangement and can be displaced by means of a clamping screw in the direction towards a conductor insertion duct and is designed so as to fixedly clamp the inserted conductor to the clamping element inner edge and/or to a current rail, wherein the clamping bracket comprises a retaining protrusion that essentially absorbs the forces that occur between the clamping bracket and the conductor in the case of a force closure between the clamping bracket and the inserted conductor, in such a manner that the pendulum bearing arrangement between the clamping bracket and the clamping element is relieved of forces in a parallel manner with respect to the clamping screw direction.

A disadvantage in the case of this prior art is that the transmission of force from the connection screw to the electrical conductor, in particular in dependence upon the cross-section of the inserted electrical conductor, is not optimal.

### OBJECT OF THE INVENTION

The object of the invention resides in proposing a parallel screw connection that on the one hand is as variable as possible with regard to the cross-section of the electrical conductor, and that in particular irrespective of the cross-section of the electrical conductor ensures an efficient as possible transmission of force between the screw force and the clamping force.

This object is achieved in a first aspect using a parallel screw connection of the type mentioned in the introduction by means of the features of the characterizing part of the independent main claim 1.

In a further aspect, the object is achieved using a method of the type mentioned in the introduction by means of the features of the characterizing part of the independent co-ordinated claim 15.

The screw force describes the force that the connection screw exerts on the clamping element. The clamping force extends ideally in a perpendicular manner thereto and describes the force with which the electrical conductor is pressed by the clamping element against the current rail. The quality of the transmission of force is determined by means of the quotient of the screw force and the clamping force.

The term “parallel screw connection” is understood to mean an electrical connection that is provided so as to connect in an electrically conductive manner an inserted electrical conductor, preferably an electrical cable on its stripped region, by way of example to a current rail, wherein the axis of the connection screw that is part of the screw connection extends in parallel with respect to the inserted electrical conductor. The force vector that occurs by virtue of screwing in the connection screw and as a consequence is directed initially in a parallel manner with respect to its axis must therefore be deflected ideally at a right angle with respect to its original direction by means of a clamping element. As a consequence, the clamping element presses the electrical conductor, with which it is in direct mechanical contact by virtue of screwing in the connection screw, against the the current rail, as a result of which a generally very good electrically conductive contact is provided between the electrical conductor and the current rail.

The screw connection can comprise for this purpose a connection housing that comprises a first aperture on a first face and a second aperture on a second face that lies opposite the first face.

The first aperture can be provided for inserting one of the two ends of the current rail; the second aperture can be used to receive the electrical conductor. Thus, the current rail and the electrical conductor, in particular the electrical cable and its associated stripped region, can be inserted into the connection housing from opposite-lying directions and mutually contacted therein in an electrical manner.

Furthermore, the connection housing comprises on its second face a circular screw aperture that preferably has an inner thread. It is possible even in the non-contacted state for the connection screw to be already inserted at least in part into this screw aperture. The connection screw is screwed in from the same direction from which the electrical conductor in particular the stripped region of the electrical cable is also inserted so that the screw connection is a parallel screw connection.

This parallel arrangement renders it possible to use a plurality of such screw connections by way of example in a terminal block and to arrange said screw connections both above and also adjacent to one another in an insulating body which renders possible an accordingly simple handling and allocation. It is thus possible in a small space to insert and connect a plurality of electrical cables clearly arranged in such a terminal block.

Advantageous embodiments of the invention are disclosed in the subordinate claims.

The present invention has the advantage that an optimum contact pressure can also be ensured irrespective of the respect cable cross-section.

A further advantage resides in the fact that an electrical cable that is to make contact with the current rail only needs to be stripped of the insulation in a comparatively short region which facilitates the expenditure with regard to the handling.

Furthermore, the high clamping force that is ensured by virtue of the efficient transmission of force renders possible a safe and reliable assembly and a stable contacting arrangement even over a comparatively long period of time and in particular also when exposed to the influences of vibrations.

It is particularly advantageous if the clamping element is embodied in a symmetrical manner, in particular this symmetry is with regard to a rotation about its axis of rotation by a discrete angle, in other words the symmetry is an n-fold symmetry of rotation because as a consequence it can ensure even in different rotational positions, that the transmission of force is identical in each case and thus also that the identical clamping force can be applied.

It is particularly advantageous that the clamping element is mounted in the connection housing in such a manner that said clamping element can perform both a translational movement and also a rotational movement relative to the connection housing. In particular, it is of particular advantage if the clamping element comprises in a symmetrical manner with respect to its axis of rotation a preferred cylindrical wheel axle that is mounted in a displaceable manner in a slot or in multiple slots of the connection housing, the reason being that as a consequence the translational movement is rendered possible in the form of a displacement of the clamping element in the direction towards the electrical conductor and also a rotational movement about its axis of rotation. This variable adjustment of the position of the clamping element renders it possible eventually to achieve a uniform high clamping force on electrical conductors that have different diameters, in particular cables that have different cross-sections.

The axis of rotation describes the idealized axis about which the clamping element rotates. The wheel axle on the other hand describes the axle that is achieved in a mechanical manner and is preferably cylindrical and is formed as one on the clamping element or is attached to said clamping element.

It is thus particularly advantageous that both the displacement (translational movement) and also the rotation (rotational movement) of the clamping element about its axis of rotation is produced by virtue of screwing in the connection screw, in other words by virtue of a single action because this simplifies the handling. Consequently both an optimized adjustment of the screw connection to suit the cable thickness and also the contact itself is performed by means of a single action.

The clamping element is advantageously embodied as a toothed wheel, wherein the teeth of the toothed wheel comprise in each case two edges of which a first edge can have a concave form and a second edge can have a convex form. The concave form is particularly well suited for offering the connection screw a suitable contact point and in fact over a sufficiently large rotational region and a sufficiently large displacement region of the toothed wheel. The convex form on the other hand is particularly well suited to press the electrical conductor against the current rail by virtue of rotating the toothed wheel constantly by means of an area element that is arranged at a right angle with respect to the electrical conductor.

With a number n of teeth, the toothed wheel that represents in this case the clamping element comprises an n-fold symmetry of rotation since said toothed wheel has in each case the identical form as it rotates about its axis of rotation by a discrete angle δ. This discrete angle δ is formed from the quotient for 360° and this number n of the teeth:

δ=360°/n

If n is an even number, then the clamping element in particular the toothed wheel comprises in addition also a mirror symmetry with respect to its axis of rotation, in other words it is also embodied in an axis symmetrical manner.

Furthermore, by virtue of screwing in the connection screw, the clamping element is able to be displaced in a translational movement in the direction towards the electrical conductor and the current rail that is to be contacted by said clamping element. This displacement can be rendered possible for example by virtue of the fact that the connection housing comprises in each case a slot on a third face and on one of its opposite-lying four faces that are preferably arranged in a perpendicular manner with respect to the first face and second face, wherein the two slots are arranged in a mirror symmetrical manner with respect to one another and preferably extend in a straight line.

The clamping element that is preferably a toothed wheel can comprise in particular in a symmetrical manner about its axis of rotation a cylindrical through-going aperture. A wheel axle that is preferably embodied as a cylindrical pin can be inserted into this through-going aperture. As an alternative thereto, a cylindrical wheel axle can also be formed as one on both sides on the clamping element, in particular about its axis of rotation, so that the clamping element can also be embodied as one piece together with the wheel axle.

The wheel axle can thus engage on both sides into the respective slot, wherein the diameter of the wheel axle preferably corresponds to the width of the slot. As a consequence, the clamping element is held in the connection housing on the one hand in a displaceable manner and on the other hand in addition also in such a manner as to be able to rotate about its axis of rotation.

The slots can also be curved, by way of example extend in the form of an ellipse. However, it is preferred that the slots extend in a straight line. In particular, the direction towards the slots that extend in a straight line inclines with respect to the current rail.

It is assumed that the axis of the connection screw extends in the Y-direction for the purposes of the following detailed description.

For an angle α that is formed between the axis of the slot and a plane that extends in a perpendicular manner with respect to the axis of the connection screw, this means that a is greater than 0°, preferably greater than 10°, particularly preferred greater than 20°, in particular greater than 25°, in other words it can amount to by way of example 30° and more. Furthermore, α can be less than 60°, preferably less than 50° and in particular less than 45°.

The angle between the axis of the connection screw and the axis of the slot accordingly amounts to (90°—α).

If the slot is bent in a curve-shaped manner, then it is possible to measure the angle α between the tangent to the corresponding curve shape in the bearing point and the X-axis.

The term ‘bearing point’ refers to the point on the slot at which the wheel axle is located and at which said wheel axle is in mechanical contact with the third face or fourth face of the connection housing.

A particular advantage of the inclined progression of the slot resides in the fact that the face parts in the region of the bearing point can absorb at least some of the counterforce with respect to the clamping force. It is thus particularly advantageous that on the one hand at least a portion of the counterforce with respect to the clamping force can be absorbed by the bearing, in other words by the third face part and the fourth face part in the region of the slot, since this renders possible a particular efficient transmission of force. Nonetheless, the clamping element can be displaced simultaneously in a particularly transverse manner, as a consequence of which the identical particularly efficient transmission of force is also ensured for cables that have cross-sections of different dimensions.

As the connection screw is screwed in, the clamping element is initially moved in the direction towards the electrical conductor and rotates advantageously in such a manner about its axis of rotation that the connection screw finds a suitable contact area on the clamping element, preferably on the convex face of a tooth of the toothed wheel. Accordingly, the relative position between the clamping element and the electrical conductor remains constant irrespective of the respective cable cross-section. By virtue of rotating the clamping element, in particular the toothed wheel, the clamping force is applied to the electrical conductor, in particular the stripped region of the electrical cable, and thus presses the cable against the current rail. The connection screw always finds a suitable contact point on the concave edge of the respective tooth of the toothed wheel so that the same efficient transmission of force is also ensured for different positions of the toothed wheel.

If it is assumed that the screw force is vertical (Y-direction) and the clamping force is horizontal (X-direction), then the following two-dimensional vector consideration is produced for the final contact state:

The following equilibrium of forces is produced in the vertical (Y) direction:

A force vector Fy2 that is absorbed by the bearing acts together with a frictional force vector Fy3 of the clamping element on the electrical conductor against the screw force vector Fy1:

Fy1=Fy2+Fy3

The following equilibrium of forces is produced in the horizontal (X) direction:

A force vector Fx2 that is absorbed by the bearing acts together with a frictional force vector Fx1 of the clamping element on the connection screw against the clamping force vector Fx3:

Fx1+Fx2=Fx3

The clamping force and the frictional force of the clamping element at the cable are related to one another by way of the material-specific coefficient of friction p:

Fy3=μFx3

The screw force and the frictional force of the clamping element at the connection screw are related to one another likewise by way of the material-specific coefficient of friction p:

Fx1=μFy1

The following applies for the forces at the bearing point:

Fx2=Fy2(sin30°+μcos30°)/(cos30°+μsin30°)

The following is thus produced in dependence upon the angle α and the respective material:

Fx3=Fy1(μ²sinα+2μcosα+sinα)/(μ²cosα+2μsinα+cosα)

By way of example, the clamping element can be manufactured from steel. For the use of such a clamping element that is manufactured from steel, a material-specific coefficient of friction μ of 0.2 is produced.

The angle α lies between the axis A and a plane that extends in a perpendicular manner with respect to the screw axis. The axis A is the axis of the straight slot or of the tangent to the curved slot in the bearing point. By way of example 30° can be assumed as a realistic value for the angle α.

The following is then produced as the theoretically calculated value for the transmission of force:

Fx3/Fy1=78.7%

This value applies for a straight slot irrespective of the position of the bearing point, in other words the position of the wheel axle at the slot.

The design is however naturally not limited to the use of steel. On the contrary, it is also possible for example to use brass, copper, aluminum, synthetic material, ceramics or any other suitable material. Also, this material does not need to be electrically conductive.

Consequently, it is ensured particularly by virtue of using straight slots that electrical conductors that have different diameters, in other words by way of example electrical cables that have different cable cross-sections, still experience the identical clamping force since for each position of the clamping element the identical conditions prevail as the clamping element is pressed against the electrical cable.

If the radius of the toothed wheel is defined as the spacing between the tip of its teeth and its axis of rotation, then the slot length is less than the sum of this radius of the toothed wheel and the diameter of the connection screw. Furthermore, it is advantageous if the slot extends between the axle of the connection screw and the current rail and by way of example commences in the region of the screw axle.

In a particularly preferred embodiment, the slot length is less than or equal to the diameter of the connection screw. The identical transmission of force is ensured in this manner for all possible transverse positions of the clamping element, in particular of the toothed wheel.

### EXEMPLARY EMBODIMENT

An exemplary embodiment of the invention is illustrated in the drawings and is further explained hereinunder.

In the drawings:

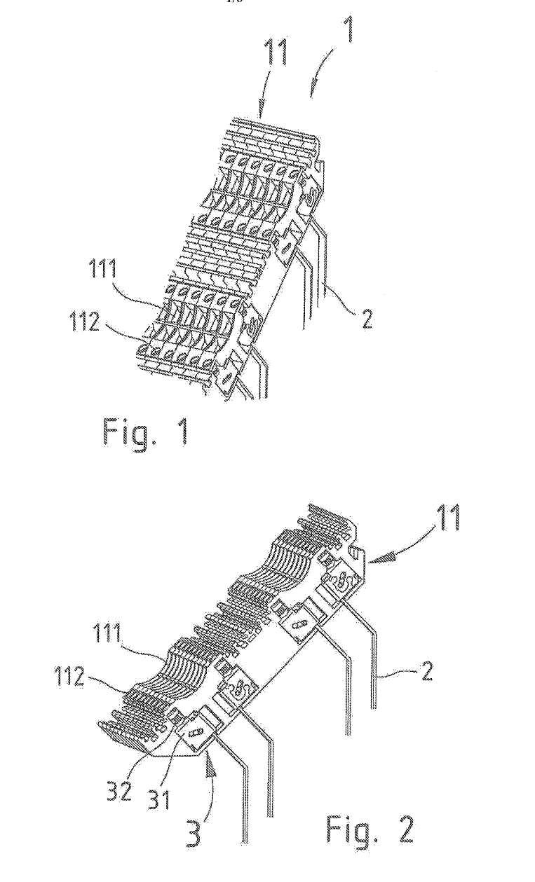

FIG. 1 illustrates a perspective view of a terminal block;

FIG. 2 illustrates a perspective view of a segment of a terminal block;

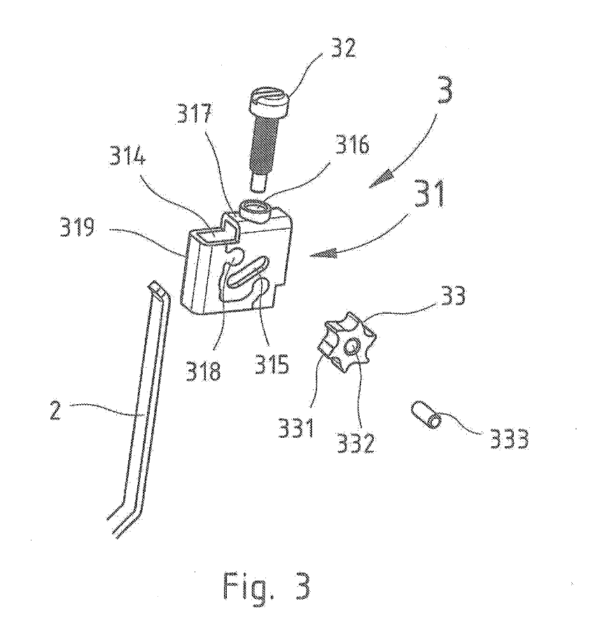

FIG. 3 illustrates an exploded view of a non-assembled screw connection with a connection housing and a separate toothed wheel, wheel axle, connection screw and current rail in an exploded view;

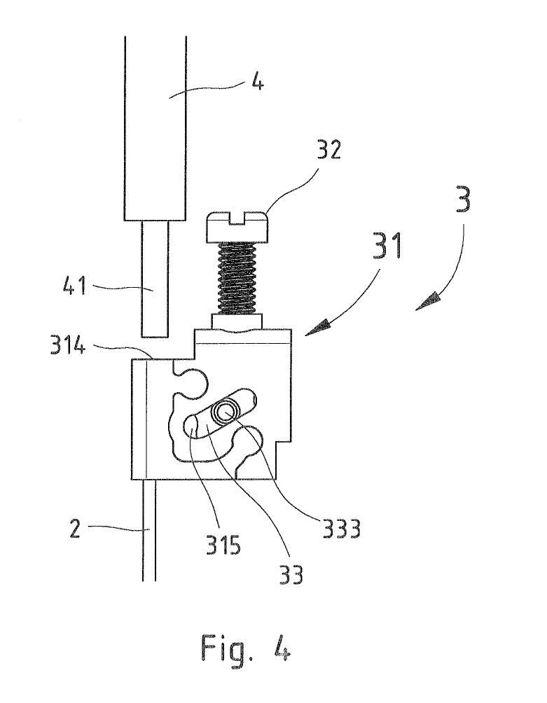

FIG. 4 illustrates a lateral view of the assembled screw connection with the inserted current rail;

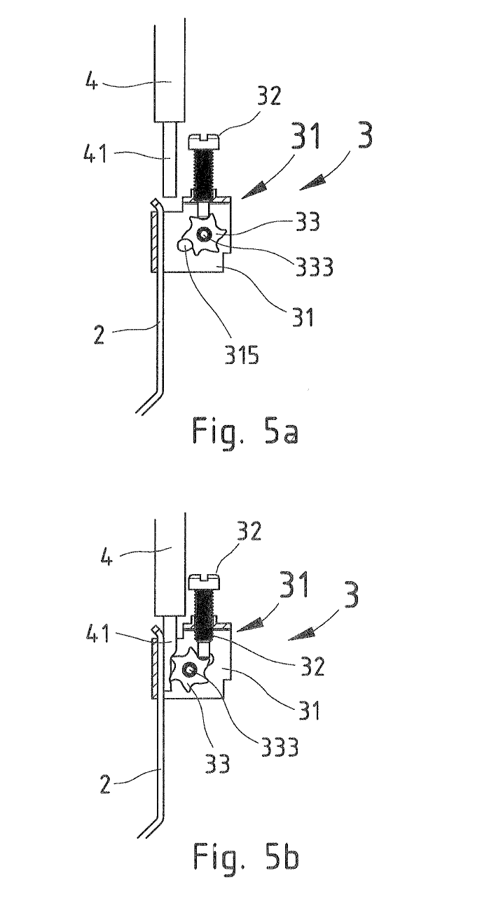

FIG. 5a illustrates a cross-sectional view of the screw connection with the inserted current rail and a connection screw that is not screwed in and showing a cable that is to be inserted;

FIG. 5b illustrates a cross-sectional view of the screw connection in a state in which it makes contact with an inserted cable and a connection screw that has been screwed in;

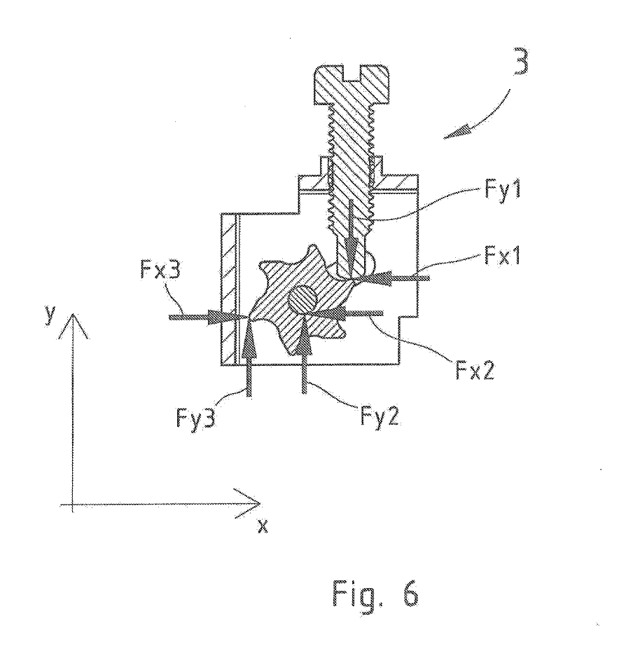

FIG. 6 illustrates a view of the force vectors in the screw connection in the contacted state;

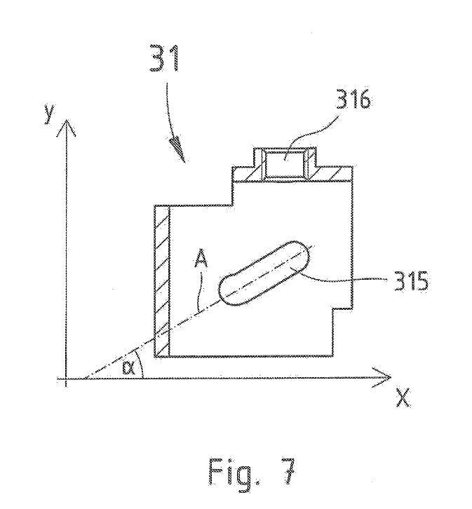

FIG. 7 illustrates the connection housing in the lateral view having a straight slot and an indicated axis of the slot.

The figures include in part simplified schematic views. Identical reference numerals are sometimes used for identical elements but where appropriate also for non-identical elements. Different views of identical elements can be scaled differently.

FIG. 1 illustrates a terminal block having an insulating body 1 that comprises multiple segments 11. Each segment 11 comprises in each case multiple cable entries 111 and each cable entry 111 is allocated a screw aperture 112.

FIG. 2 illustrates a cross-sectional view in particular of a single segment 11 of the insulating body 1 with four current rails 2 that are inserted therein in an exemplary manner and four parallel screw connections 3 that are likewise inserted in an exemplary manner having in each case a connection housing 31 and a connection screw 32, wherein one end of the respective current rail 2 is arranged in the respective connection housing 31 of the screw connection 3. In this manner, the respective current rail 2 is arranged at least in part in the segment 11 of the insulating body 1 and thus is also arranged in the insulating body 1. Furthermore, the respective current rail 2 is arranged at least in part in the respective connection housing 31 of the screw connection 3.

FIG. 3 illustrates an exploded view of a non-assembled screw connection 3 together with a current rail 2 that is inserted in the connection housing 31 that is associated with the screw connection 3. The connection housing 31 can be preferably embodied as a stamped and bent part.

In order to insert the current rail 2, the connection housing 31 comprises, in a first face that is covered by means of the connection housing 31 and is therefore not visible in the drawing, a first aperture that is accordingly likewise not visible in the drawing. In order to insert an electrical conductor, in particular a stripped region 41 of an electrical cable 4, the connection housing 31 comprises a second aperture 314 in a second face 317 that is arranged lying opposite the first face. Furthermore, a screw aperture 316 is arranged in this second face 317 and said screw aperture comprises an inner thread.

The current connection 3 comprises also a connection screw 32 that fits into the screw connection 316.

The connection housing 31 comprises a third face 318 and a fourth face 319 that are perpendicular to the first and the second face 317. These two faces 318, 319 comprise in each case a preferred straight slot 315, wherein the two slots lie symmetrically opposite one another. Only one slot 315 is visible in the drawing because the other one is covered by the connection housing 31.

Furthermore, the screw connection 3 comprises a clamping element, in particular a toothed wheel 33 that preferably comprises multiple teeth 331 that have in each case a concave edge and a convex edge. The toothed wheel 33 comprises in its middle a cylindrical through-going aperture 332. Furthermore, the toothed wheel 33 comprises a wheel axle 333 that is embodied in a cylindrical manner and can be inserted in a positive-locking manner into said through-going aperture 332.

FIG. 4 illustrates a lateral view of the assembled screw connection 3 with the inserted current rail 2.

The wheel axle 333 is inserted in a positive-locking manner into the cylindrical through-going aperture 332 of the toothed wheel 33 and the toothed wheel 33 is held in a displaceable and rotatable manner by means of this wheel axle 333 in the slots 315 of the connection housing 31. The toothed wheel 33 is arranged in this manner in the connection housing 3, The connection screw 32 is screwed in in part into the screw aperture 316.

Furthermore, an electrical cable 4 is illustrated as an electrical conductor with a stripped region 41. The current rail 2 has already been inserted through the first aperture into the connection housing 31. The electrical cable 4 is thus provided with its stripped region 41 to be inserted through the second aperture into the connection housing. A portion of the toothed wheel 33 is visible through the slot 315. Furthermore, the figure illustrates how the toothed wheel 33 is held in a rotatable and displaceable manner by means of the wheel axle 331 in the slot 315.

FIG. 5a illustrates a cross-sectional view of the same arrangement. The connection screw 32 is screwed in as far as a depth that is necessary so as to make a first mechanical contact with the toothed wheel 33.

As the connection screw 32 is screwed in, the toothed wheel 33 displaces initially in the direction towards the contacting stripped region 41 of the electrical cable 4. It is irrelevant whether the toothed wheel 33 also automatically performs an additional rotational movement; it is important that the toothed wheel 33 during this procedure in any case also comprises a movement component that corresponds to a translational movement, in other words the axis of rotation of the toothed wheel 33 in the form of its wheel axle 331 moves along the slot 315 in the direction towards the electrical conductor, namely in this case in the direction towards the stripped region 41 of the electrical cable 4, and as a consequence naturally also in the direction towards the current rail 2.

As soon as, as illustrated in FIG. 5b, the mechanical contact is provided between the toothed wheel 331 and the electrical conductor, in this case the stripped region 41 of the electrical cable 4, the connection screw 32 exerts a corresponding force on the toothed wheel 33. This screw force acts in particular on a tooth of the toothed wheel 33 and in particular on the convex edge of a tooth of the toothed wheel 33. The toothed wheel 33 exerts by way of a rotational movement a corresponding force on the electrical conductor, in particular on the electrical cable 4 on its stripped region 41, and consequently presses it against the current rail 2.

As a consequence, the electrical contact is provided between the electrical conductor, which is in particular the electrical cable 4, and the current rail 2.

FIG. 5b illustrates for this purpose, in a view that is comparable to FIG. 5a, the electrical cable 4 that is inserted with its stripped region 41 into the connection housing 31. The connection screw 32 is finally screwed in so as to make the contact.

It is obvious that the current rail 2 on the one hand and the electrical conductor, in particular the electrical cable with its stripped region 41, on the. other hand are inserted from opposite directions into the connection housing. The electrical cable 4 and the current rail extend within the connection housing in a parallel manner and furthermore in a parallel manner with respect to the axis of the connection screw.

FIG. 6 illustrates the equilibrium of forces in the screw connection for the above mentioned state in which the connection screw 32 is screwed in and the electrical contact is finally provided between the electrical conductor, in particular the stripped region 41 of the electrical cable 4, and the current rail 2. The electrical cable 4 and the current rail 2 are not illustrated in this view for reasons of clarity.

If it is assumed that the screw force is vertical (Y direction) and the clamping force is horizontal (X direction), then the following vector consideration is produced for the above described equilibrium of forces:

The following equilibrium of forces is produced in the vertical (Y) direction:

A force vector Fy2 that is absorbed by the bearing acts together with a frictional force vector Fy3 against the screw force vector Fy1, wherein the frictional force vector Fy3 describes the frictional force between the clamping element and the electrical conductor:

Fy1=Fy2+Fy3

The following equilibrium of forces is produced in the horizontal (X) direction:

A force vector Fx2 that is absorbed by the bearing acts together with a frictional force vector Fx1 against the clamping force vector Fx3, wherein the frictional force vector Fx1 describes the frictional force between the connection screw and the clamping element:

Fx+Fx2=Fx3

The clamping force and the frictional force of the clamping element at the cable are related to one another by way of the material-specific coefficient of friction μ:

Fy3=μFx3

The screw force and the frictional force of the clamping element at the connection screw are related to one another likewise by way of the material-specific coefficient of friction μ:

Fx1=μFy1

For the forces at the bearing point is applicable in dependence upon the angle of inclination α, the by way of example the axis A of the straight slot forms with the X-axis; in the case of a curve-shaped slot, the angle α is formed by the tangent of this curved shape in the bearing point and the X-axis:

Fx2=Fy2(sin30°+μcos30°)/(cos30°+μsin30°)

The following is thus produced in dependence upon the angle α and the respective material of the terminal body:

Fx3=Fy1(μ²sinα+2μcosα+sinα)/(μ²cosα+2μsinα+cosα)

By way of example, the clamping element can be manufactured from steel. For the use of such a clamping element that is manufactured from steel, by way of example a material-specific coefficient of friction u of approx. 0.2 is produced. The design is however naturally not limited to the use of steel. On the contrary, it is also possible for example to use brass, copper, aluminum, synthetic material, ceramics or any other suitable material.

An angle of by way of example 30° can be assumed as the angle α.

The following is then produced as the theoretically calculated value for the transmission of force:

Fx3/Fy1=78.7%

Since the slot 315 extends in a straight line, this value applies irrespective of the position of the bearing point, in other words irrespective of the position of the wheel axle 331 at the slot 315.

FIG. 7 illustrates a lateral view of the connection housing 31. The straight slot 315 is clearly visible. In particular, the axis A of said straight slot is clearly visible and includes an angle α of 30° with the X-axis of the said coordinate system.

### LIST OF REFERENCE NUMERALS

1 Insulation body
11 Segment of the insulation body
111 Cable feed
112 Screw aperture
2 Current rail
3 Screw connection
31 Connection housing
314 Second aperture
315 Slot
316 Screw aperture
317 Second face
318 Third face
319 Fourth face
32 Connection screw
33 Toothed wheel
331 Tooth of the toothed wheel
332 Cylindrical through-going aperture
333 Wheel axle
4 Electrical cable, electrical conductor
41 Electrical conductor, stripped region of the electrical cable
A Axis of the straight slot

1-15. (canceled)

16. A parallel screw connection comprising at least one connection housing, a connection screw and a clamping element, wherein the clamping element is mounted in or on the connection housing both in a displaceable manner and also in such a manner as to be able to rotate about an axis of rotation.

17. The parallel screw connection as claimed in claim 16, wherein the connection housing comprises a slot in each case on opposite-lying faces.

18. The parallel screw connection as claimed in claim 17, wherein the clamping element comprises a wheel axle that is held in the slot in a displaceable manner and a rotatable manner.

19. The parallel screw connection as claimed in claim 18, wherein the wheel axle is embodied in a cylindrical manner and comprises an axis of symmetry.

20. The parallel screw connection as claimed in claim 19, wherein the terminal body is mounted in a rotatable manner with its wheel axle in the slots, and wherein the axis of rotation of the clamping element corresponds to said axis of symmetry.

21. The parallel screw connection as claimed in claim 16, wherein the slots

22. The parallel screw connection as claimed in claim 16, wherein the clamping element is embodied in a symmetrical manner.

23. The parallel screw connection as claimed in claim 22, wherein the clamping element is embodied in an axis-symmetrical manner with respect to its axis of rotation.

24. The parallel screw connection as claimed in claim 22, wherein the clamping element has an n-fold rotational symmetry.

25. The parallel screw connection as claimed in claim 16, wherein the clamping element is a toothed wheel having multiple teeth.

26. The parallel screw connection as claimed in claim 25, wherein each tooth of the toothed wheel has a concave edge and a convex edge.

27. A terminal block comprising an insulation body and at least one parallel screw connection as claimed in claim 16, which is arranged therein, and at least one current rail that is arranged at least in part in the insulation body.

28. The terminal block as claimed in claim 27, wherein the current rail is arranged at least in part in the connection housing of the parallel screw connection.

29. The terminal block as claimed in claim 27, wherein the insulation body comprises at least one cable entry through which an electrical conductor can be inserted into the parallel screw connection, and the insulation body furthermore comprises at least one screw aperture through which the connection screw can be screwed into the connection housing so as to provide a contact between the electrical conductor and the current rail.

30. A method for providing an electrical contact between an electrical conductor wherein a connection screw is screwed into the connection housing in a parallel manner with respect to the current rail and the electrical conductor, and as a consequence presses a clamping element against the electrical conductor and presses this electrical conductor against the current rail, as a consequence of which the electrical conductor makes electrical contact with the current rail, wherein the clamping element is initially displaced in a direction towards the electrically conductor by virtue of screwing in the connection screw, subsequently makes mechanical contact with the electrical conductor and rotates about an axis of rotation by virtue of screwing the connection screw further in and as a consequence presses the electrical conductor against the current rail.
